(19) United States
(12) Patent Application Publication
(10) Pub. No.: US 2011/0268287 A1
(43) Pub. Date: Nov. 3, 2011

(54) LOUDSPEAKER SYSTEM AND SOUND EMISSION AND COLLECTION METHOD

(75) Inventor: Toshiaki Ishibashi, Fukuroi-shi (JP)

(73) Assignee: YAMAHA CORPORATION, Hamamatsu-shi, Shizuoka (JP)

(21) Appl. No.: 13/143,836

(22) PCT Filed: Jan. 8, 2010
(86) PCT No.: PCT/JP2010/050179

§ 371 Date: Jul. 8, 2011

(30) Foreign Application Priority Data
Jan. 8, 2009 (JP) 2009-002271

(51) Int. Cl. H04B 3/20; H04R 1/00

(52) U.S. Cl. 381/66; 381/163

(57) ABSTRACT

A loudspeaker system with a high degree of versatility, which, even when a microphone or a person speaking moves, can adequately response to the movement is provided. A plurality of linkage terminals 2 are connected to a central control device 1. A lecturer operates the central control device 1 to designate whether each of the linkage terminals 2 functions as a speaker or as a microphone. It is possible to, through the central control device 1, designate which linkage terminals 2 function as a microphone or as a speaker. Therefore, the lecturer can switch with one touch operation the locations and the number of microphones and speakers in accordance with the situation during a lecture, such as a situation where the lecturer makes a lecture, that where a questioner is asking a question, or that where the master of meeting gives an explanation. For example, an assistant is not required to go to the trouble of bringing a microphone to a questioner, it is possible to adequately response to the moving state of the person speaking, and the versatility and the convenience are extremely high.

### TECHNICAL FIELD

The present invention relates to a loudspeaker system which is to be installed in a large space such as a hall, and also to a sound emission and collection method which uses the loudspeaker system.

### BACKGROUND ART

Conventionally, in the case where a loudspeaker system is installed in a large space such as a hall, the directionality of sound collection and that of sound emission become problematic. Namely, the voice of the lecturer (person speaking) must be collected at a high SN ratio, and the voice of the person speaking must be accurately transmitted to the position of the listener.

For example, Patent Document 1 proposes a technique in which speakers are distributedly placed in the ceiling, and uniform sound pressure characteristics are realized at the position of the listener.

### RELATED ART DOCUMENTS

### Patent Documents

Patent Document 1: JP-A-2004-112283

### SUMMARY OF THE INVENTION

### Problems to be Solved by the Invention

In the speaker system of Patent Document 1, however, the speakers are installed in on the ceiling or the like, and hence the degree of freedom of installation is so low that the system lacks versatility. Since the system is fixedly installed, the initial installation cost is required.

In the speaker system of Patent Document 1, furthermore, consideration is not given to the sound collection side (microphone), and the convenience in the case where the person speaking moves is not considered. When the person speaking moves, the acoustic feedback system is changed, and the loud-speaking state may possibly become unstable.

Therefore, it is an object of the invention to provide a loudspeaker system which has a high degree of versatility, and which, even when a person speaking moves, can adequately response to the movement, and a sound emission and collection method which uses the loudspeaker system.

### Means for Solving the Problem

In the present invention, it is provided that loudspeaker system comprising:

a central control device; and

a plurality of linkage terminals which are connected to the central control device,

wherein the central control device includes:
a control circuit which transmits a control command indicating whether each of the plurality of linkage terminals functions as a speaker or as a microphone; and
an audio signal processing portion which, when receiving an audio signal from a linkage terminal that functions as a microphone, applies audio signal processing to the audio signal, and which outputs the audio signal subjected to the audio signal processing to a linkage terminal that functions as a speaker; and

wherein each of the plurality of linkage terminals includes:
a sound collection portion which collects sound;
a sound emitting portion which emits sound; and
a terminal control circuit which, when receiving a control command for causing the linkage terminal to function as the microphone from the central control device, controls to output the sound that is collected by the sound collection portion to the audio signal processing portion of the central control device, and which, when receiving a control command for causing the linkage terminal to function as the speaker from the central control device, controls to emit sound from the sound emitting portion based on the audio signal that is input from the audio signal processing portion of the central control device.

Preferably, the audio signal processing portion includes: an adaptive pseudo echo sound removing unit which removes pseudo echo sound from the audio signal that is input from the linkage terminal; and a storage portion configured to store a plurality of initial parameters of the adaptive pseudo echo sound removing unit, and the central control device further includes a measuring portion which performs measurement on an acoustic feedback system with respect to a plurality of patterns related to functions and placements of the plurality of linkage terminals, and which determines the plurality of initial parameters based on a result of the measurement.

Preferably, the sound collection portion includes a microphone array having a plurality of microphones, and the sound emitting portion includes a speaker array having a plurality of speakers.

Preferably, the control circuit of the central control device sets either of first and second channels to the plurality of linkage terminals, and the audio signal processing portion applies audio signal processing to an audio signal which is input from a linkage terminal that is set to the first channel, and that is caused to function as a microphone, outputs the audio signal that has undergone the audio signal processing, to a linkage terminal that is set to the first channel, and that is caused to function as a speaker, applies audio signal processing to an audio signal which is input from a linkage terminal that is set to the second channel, and that is caused to function as a microphone, and outputs the audio signal that has undergone the audio signal processing, to a linkage terminal that is set to the second channel, and that is caused to function as a speaker.

Also, in the present invention, it is provided that a sound emission and collection method for a loudspeaker system including a central control device and a plurality of linkage terminals which are connected to the central control device, the sound emission and collection method comprising:

transmitting a control command indicating whether each of the plurality of linkage terminals functions as a speaker or as a microphone, from the central control device;

outputting an audio signal which is collected by the linkage terminal to the central control device by a linkage terminal which receives a control command that causes the linkage terminal to function as the microphone;

when the central control device receives the audio signal from the linkage terminal which is caused to function as the microphone, applying audio signal processing to the audio signal, and outputting the audio signal subjected to the audio signal processing; and

emitting sound from a sound emitting portion based on the audio signal that is input from the central control device by a linkage terminal which receives a control command that causes the linkage terminal to function as the speaker.

Preferably, the sound emission and collection method further comprises:

performing measurement on an acoustic feedback system with respect to a plurality of patterns related to functions and placements of the plurality of linkage terminals;

determining a plurality of initial parameters based on a result of the measurement in the measurement step; and

removing pseudo echo sound from audio signals that are input from the plurality of linkage terminals, by using the plurality of initial parameters which are read out from a storage portion.

Preferably, the sound emission and collection method further comprises:

setting either of first and second channels to the plurality of linkage terminals;

applying audio signal processing to an audio signal which is input from a linkage terminal that is set to the first channel and that is caused to function as the microphone, and outputting the audio signal subjected to the audio signal processing to a linkage terminal that is set to the first channel and that is caused to function as the speaker; and

applying audio signal processing to an audio signal which is input from a linkage terminal that is set to the second channel and that is caused to function as the microphone, and outputting the audio signal subjected to the audio signal processing to a linkage terminal that is set to the second channel and that is caused to function as the speaker.

### Advantageous of the Invention

According to the invention, the versatility is high, and it is possible to adequately response to even in the case where a microphone or the person speaking moves.

### BRIEF DESCRIPTION OF THE DRAWINGS

FIG. 1 is a view showing the configuration of a loudspeaker system.

FIG. 2 is a view showing the configuration of a loudspeaker system.

FIG. 3 is a block diagram showing the configuration of a central control device.

FIG. 4 is a block diagram showing the configuration of linkage terminals.

FIG. 5 is a block diagram showing in detail the configuration of an audio signal processing portion.

FIG. 6 is a view showing the configuration of a loudspeaker system in the case where a collected audio signal is divided into a plurality of channels.

### MODE FOR CARRYING OUT THE INVENTION

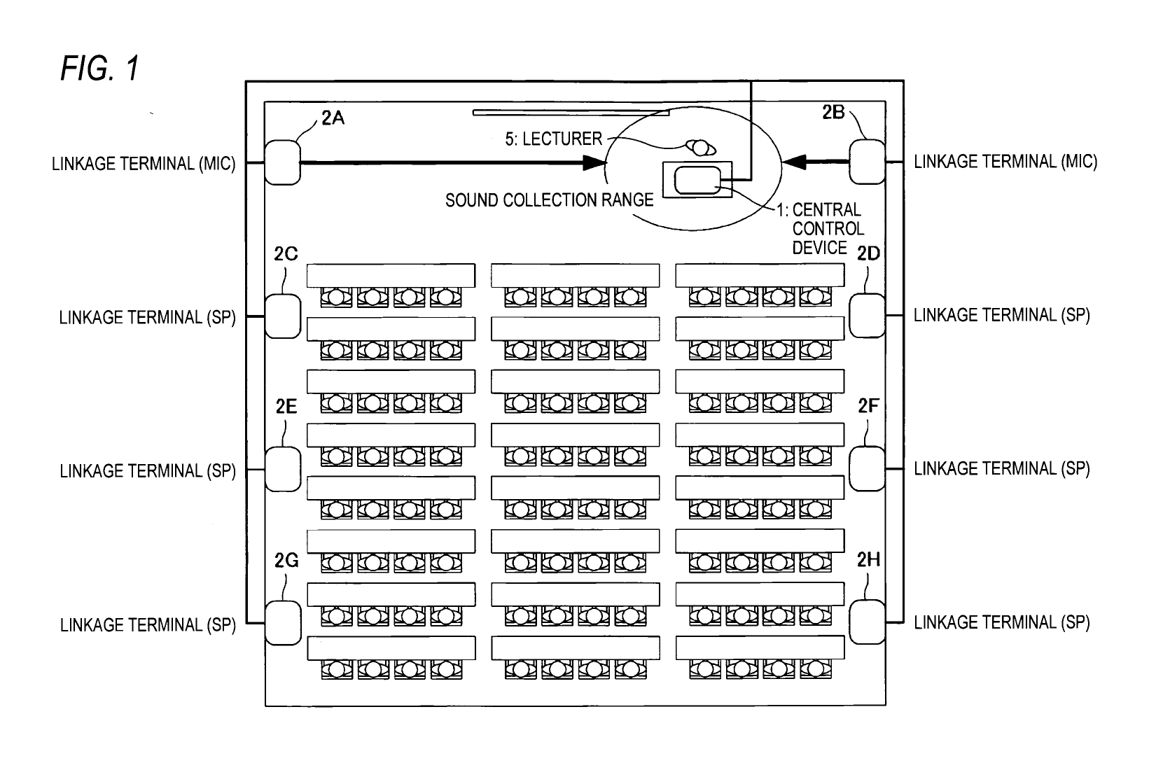

Hereinafter, a loudspeaker system (sound emission and collection system) which is an embodiment of the invention will be described with reference to the drawings. FIG. 1 is a view showing the whole configuration of the loudspeaker system.

The loudspeaker system of the embodiment is to be installed in a large space such as a hall, and is configured by a central control device 1, and a plurality of linkage terminals 2 (linkage terminals 2A to 2H) which are connected to the central control device 1. The number of the linkage terminals is not limited to the example shown in the figure.

In the example of FIG. 1, a lecturer 5 exists in the front area of the hall (the upper side of the sheet), and many listeners exist in the area extending from the middle of the hall to the rear side. The central control device 1 is placed in the vicinity of the lecturer 5, and connected to the plurality of linkage terminals 2.

The linkage terminals 2A to 2H are distributedly placed in the whole hall. For example, the linkage terminals 2A and 2B are placed in the left and right side wall faces of the front area of the hall so as to sandwich the lecturer 5. Moreover, the linkage terminals 2C and 2D are placed in the left and right side wall faces so as to sandwich the vicinity of the front lines of the listeners. Similarly, the linkage terminals 2E and 2F are placed in the left and right side wall faces so as to sandwich the vicinity of the middle lines of the listeners. Furthermore, the linkage terminals 2G and 2H are placed in the left and right side wall faces of the rear area of the hall so as to sandwich the vicinity of the rear lines of the listeners.

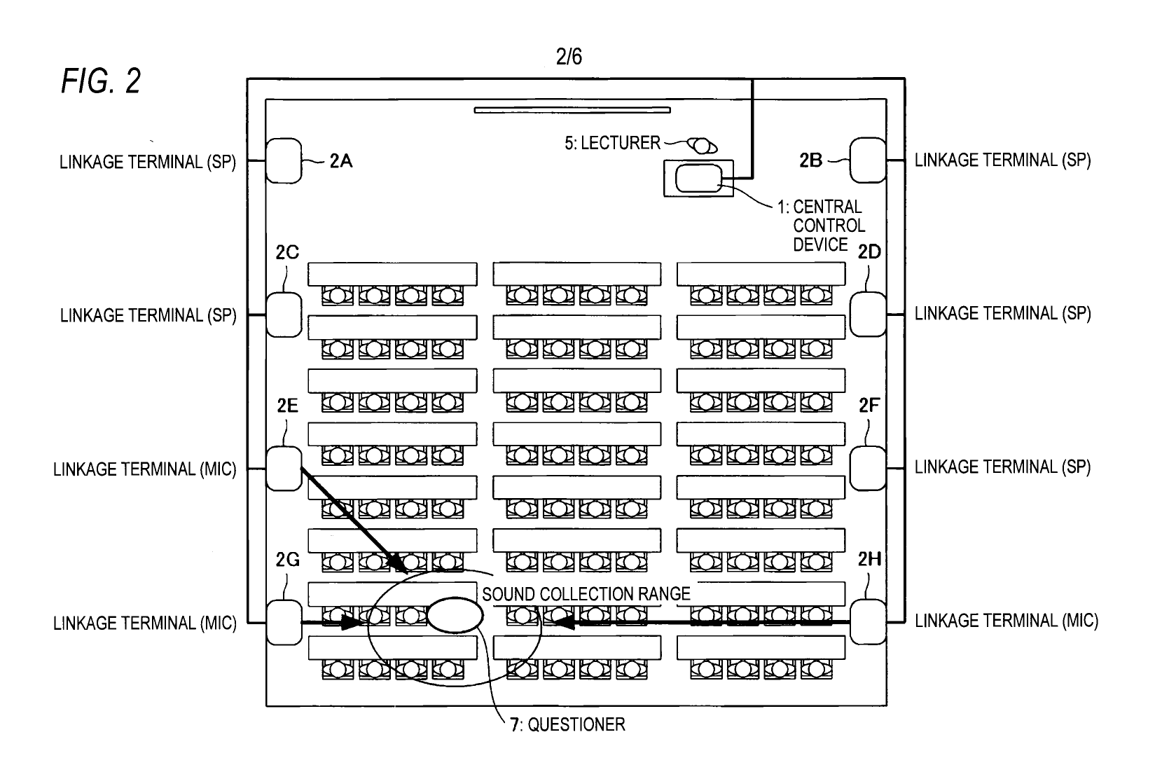

The lecturer 5 (or an assistant for the lecture, or the like) operates the central control device 1 to set the linkage terminals 2A to 2H as a speaker or as a microphone (see FIGS. 1 and 2). In the loudspeaker system of the embodiment, the central control device collectively controls the plurality of linkage terminals so that it is possible to easily change the functions of the linkage terminals between a speaker and a microphone, and the numbers and installation positions of speakers and microphones can be easily changed in accordance with the scale of the hall or the situation.

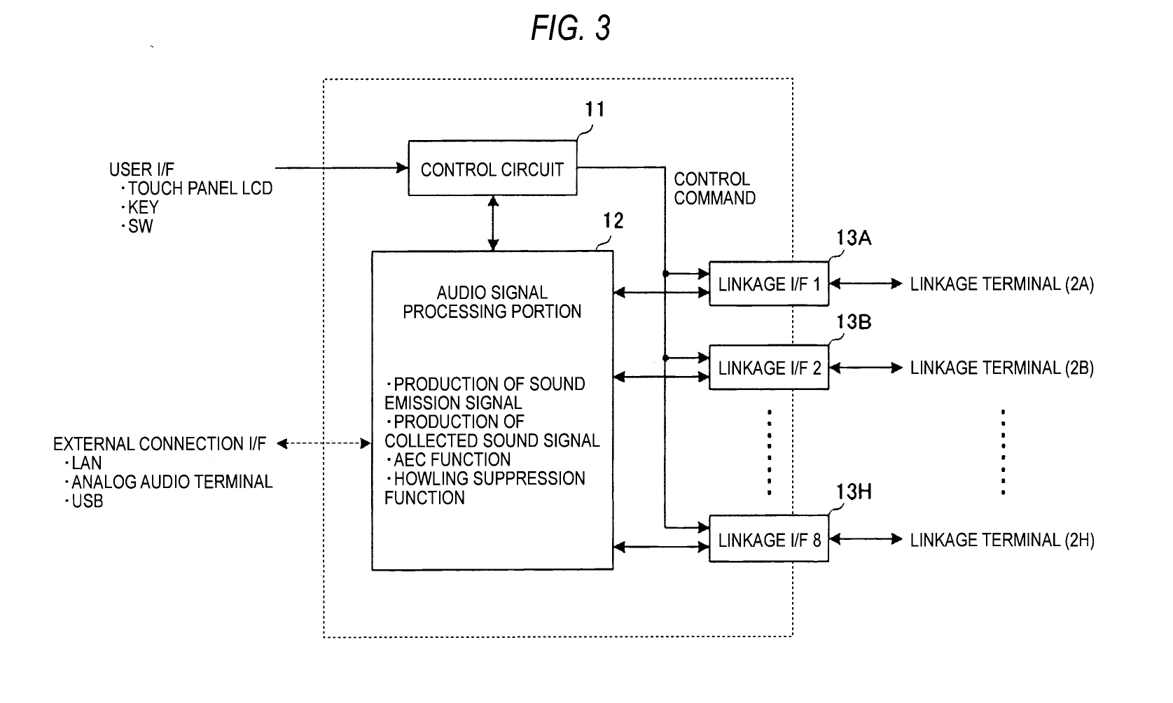

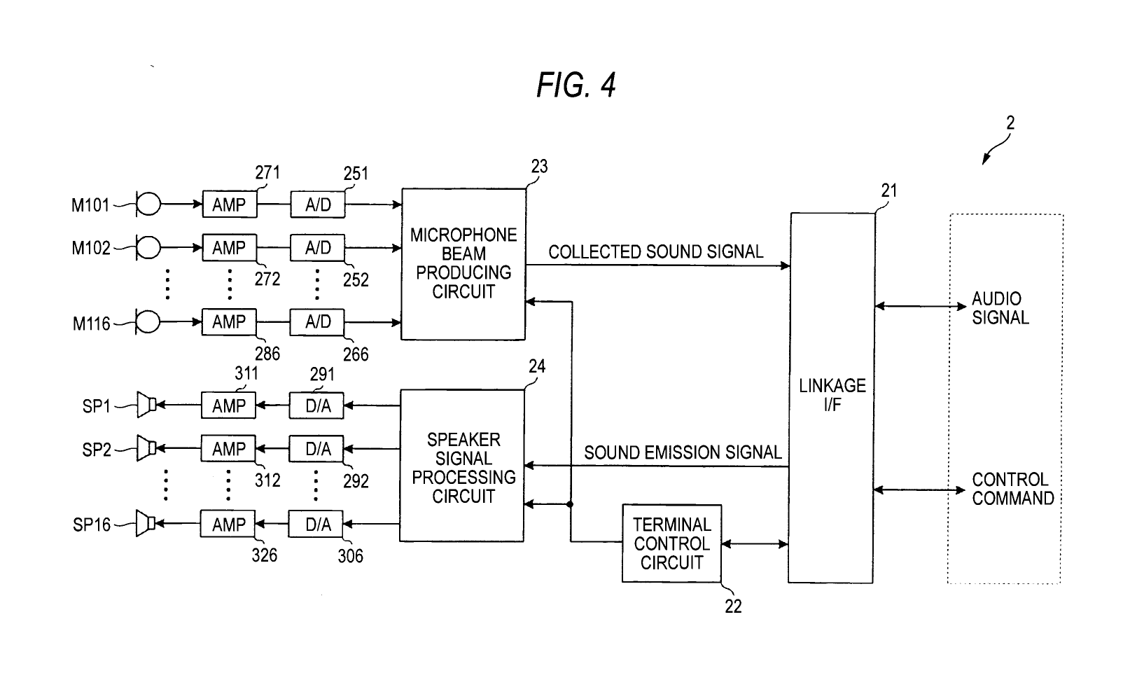

FIG. 3 is a block diagram showing the configuration of the central control device 1, and FIG. 4 is a block diagram showing the configuration of the linkage terminals 2.

The central control device 1 includes a control circuit 11, an audio signal processing portion 12, and linkage interfaces (I/Fs) 13A to 13H.

A user I/F configured by a touch panel LCD, a keyboard (key), a switch (SW), and the like is connected to the control circuit 11, and an operation of the lecturer 5 is accepted via the user I/F. The control circuit 11 controls the audio signal processing portion 12 in accordance with the operation of the lecturer 5, and controls the linkage terminals 2A to 2H through the linkage I/Fs 13A to 13H. In accordance with the operation of the lecturer 5, namely, the control circuit 11 transmits a control command to the linkage terminals 2A to 2H so that the linkage terminals function as a microphone or as a speaker. The standard of the linkage I/Fs may be a standard dedicated to a loudspeaker system, or a general purpose standard such as IEEE 1394 or USB.

External connection I/Fs such as a LAN terminal, an analog audio terminal, and a USB terminal are connected to the audio signal processing portion 12. Sound is input to or output from these terminals. For example, sound which is collected in the hall is output to a terminal in a remote meeting room through the LAN terminal and a network. Therefore, a lecture between remote locations may be realized.

The audio signal processing portion 12 receives audio signals which are collected by linkage terminals functioning as a microphone, produces a collected audio signal, and applies signal processing such as equalizer to the collected audio signal to produce a sound emission signal. The audio signal processing portion 12 outputs the produced sound emission signal, to linkage terminals functioning as a speaker.

The audio signal processing portion 12 has also a howling suppression function, an echo canceller (AEC) function, etc. Specifically, the portion incorporates an adaptive howling canceller (or an adaptive echo canceller) which removes pseudo echo sound from the audio signals which are collected by the linkage terminals functioning as a microphone. The adaptive howling canceller estimates the transfer function of the acoustic feedback system extending from the speakers to the microphones, and performs filtering on the sound emission signal to produce pseudo echo sound.

The audio signal processing portion 12 stores a plurality of initial parameters (filter coefficients and the like) of the adaptive howling canceller. The plurality of initial parameters are obtained by measurement at the installation (in calibration) of the loudspeaker system, and read out when the operation of the loudspeaker system is switched (the detail will be described later).

Next, the configuration and function of the linkage terminals will be described with reference to FIG. 4. All the linkage terminals 2A to 2H have the same configuration and function.

The linkage terminals 2 include a linkage I/F 21, a terminal control circuit 22, a microphone beam producing circuit 23, a speaker signal processing circuit 24, ND converters 251 to 266, microphone amplifiers (AMPs) 271 to 286, D/A converters 291 to 306, speaker amplifiers 311 to 326, microphones M101 to M116 (microphone array), and speakers SP1 to SP16 (speaker array).

The control command is input to the linkage I/F 21 from the control circuit 11 of the central control device 1. The control command which is input to the linkage I/F 21 is supplied to the terminal control circuit 22. Also the sound emission signal is input to the linkage I/F 21 from the audio signal processing portion 12 of the central control device 1.

When a control command instructing to function as a microphone is input, the terminal control circuit 22 sets the microphone beam producing circuit 23 so as to output the collected audio signal (microphone beam signal). When a control command instructing to function as a speaker is input, the terminal control circuit 22 sets the microphone beam producing circuit 23 so as not to output the collected audio signal, and the speaker signal processing circuit 24 so as to emit sound based on the sound emission signal supplied from the linkage I/F 21.

The microphone beam producing circuit 23 provides a predetermined delay to audio signals (signals which are digitized by the ND converters 251 to 266) supplied from the plurality of microphones M101 to M116 that form a microphone array, and then combines the audio signals together to produce a microphone beam signal. The microphone beam signal (collected audio signal) is output to the audio signal processing portion 12 of the central control device 1. The microphone beam producing circuit 23 can set the directionality of sound collection to various directions, by changing the delay amounts of the microphones.

The speaker signal processing circuit 24 provides a delay to sound emission signals which are to be supplied to the speakers SP1 to SP16 that are arranged in an array-like manner, and then outputs the signals to the D/A converters 291 to 306. The sound emission signals are converted to analog signals, and then supplied to the speakers SP1 to SP16 to be emitted as sound. The sound emitted from the speakers SP1 to SP16 is emphasized in a predetermined direction to be formed as an emitted sound beam. The speaker signal processing circuit 24 can set the directionality of sound emission to various directions, by changing the delay amounts of the speakers.

Next, the operations of the central control device 1 and the linkage terminals 2 will be described with reference to FIGS. 1 and 2. FIG. 1 is a view showing the operation in the case where the lecturer 5 is making a lecture. In this case, the lecturer 5 operates the central control device 1 to instruct the linkage terminals 2A and 2B which are placed in the front area of the hall, to be set as a microphone, and the other linkage terminals 2C to 2H to be set as a speaker.

In this case, audio signals (microphone beam signal) which are collected in the linkage terminal 2A and the linkage terminal 2B are input to the central control device 1, and subjected to mixing to be formed as a collected audio signal. In the linkage terminal 2A and the linkage terminal 2B, the peripheral region of the lecturer 5 is set as the sound collection range (directionality of sound collection). The collected audio signal contains a voice uttered by the lecturer 5.

The central control device 1 applies a process of adjusting the sound quality, such as equalizing to the collected audio signal, and outputs a resulting signal to the linkage terminals 2C to 2H as a sound emission signal. Since the linkage terminals 2C to 2H are distributedly placed in the hall, the voice uttered by the lecturer 5 is loudly emitted to the whole hall.

By contrast, in the case where a situation in which a part (questioner) of the listeners puts a question occurs as shown in FIG. 2, the lecturer 5 operates the central control device 1 to instruct linkage terminals (the linkage terminal 2E, the linkage terminal 2G, and the linkage terminal 2H) which are placed near the questioner, to be set as a microphone, and the other linkage terminals 2A to 2D and the linkage terminal 2F to be set as a speaker.

In this case, audio signals (microphone beam signal) which are collected in the linkage terminal 2E, the linkage terminal 2G, and the linkage terminal 2H are input to the central control device 1, and subjected to mixing to be formed as a collected audio signal. In the linkage terminal 2E, the linkage terminal 2G, and the linkage terminal 2H, the peripheral region of the questioner 7 is set as the sound collection range (directionality of sound collection). The collected audio signal contains a voice uttered by the questioner 7.

The central control device 1 applies the process of adjusting the sound quality, such as equalizing to the collected audio signal, and outputs a resulting signal to the linkage terminals 2A to 2D and the linkage terminal 2F as a sound emission signal. In this case, the voice uttered by the questioner 7 is loudly emitted to the lecturer 5 (and the whole hall).

FIGS. 1 and 2 show the example in which the linkage terminals are caused to function as a speaker or a microphone. It is a matter of course that the linkage terminals may be caused to function as both a speaker and a microphone. In FIG. 2, for example, the linkage terminal 2E, the linkage terminal 2G, and the linkage terminal 2H may be caused to function as a microphone and a speaker so that the voice uttered by the questioner 7 is loudly emitted to the further whole area of the hall.

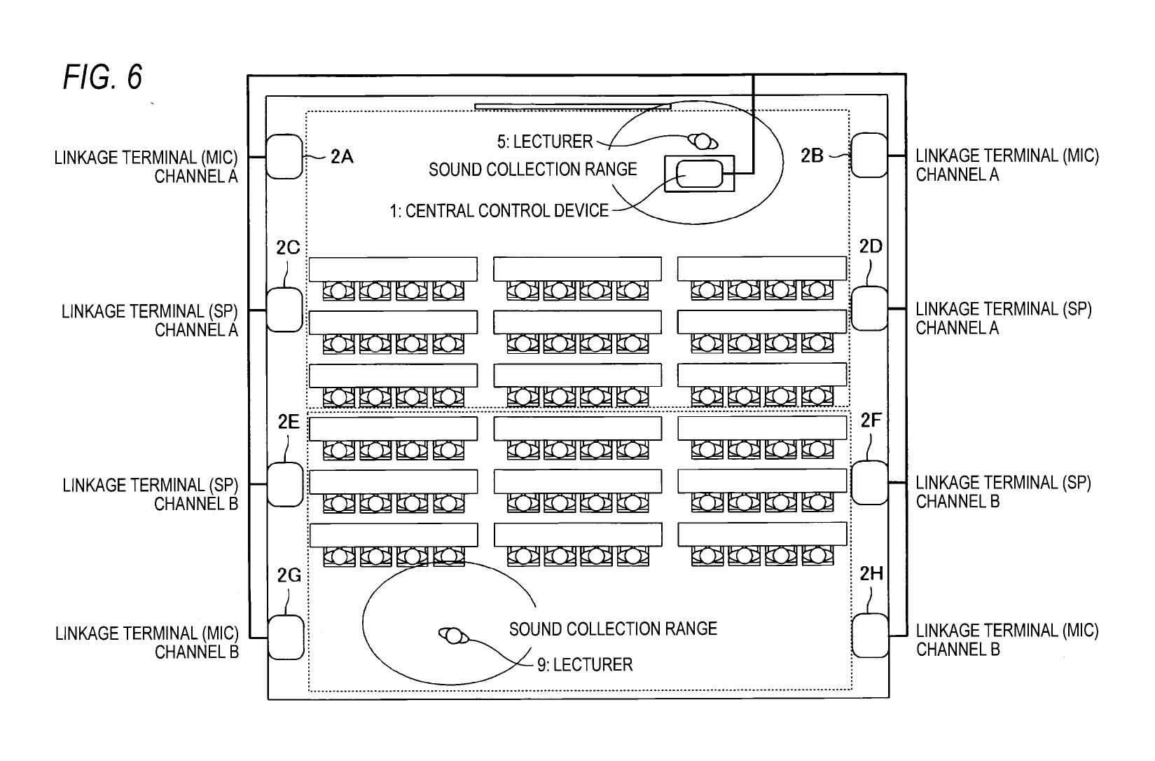

The example of FIGS. 1 and 2 shows the configuration where the central control device 1 applies a mixing process to all the sound signals supplied from the linkage terminals which function as a microphone, and outputs a resulting signal to all the linkage terminals which function as a speaker. Alternatively, the unit may be configured so that the collected audio signal is divided into a plurality of channels, and linkage terminals to which the signals are to be output are set. This is preferable in the case where, for example, different lectures are made in the same hall as shown in FIG. 6.

In the example of FIG. 6, the lecturer 5 exists in the front area of the hall, and another lecturer 9 exists in the rear area of the hall. Listeners existing in the area from the middle of the hall to the front area listen to the voice uttered by the lecturer 5, and those existing in the area from the middle of the hall to the rear area listen to the voice uttered by the lecturer 9. Also in this case, the central control device 1 is placed in the vicinity of the lecturer 5, and connected to the plurality of linkage terminals 2.

The lecturer 5 operates the central control device 1 to instruct the linkage terminals 2A and 2B which are placed in the front area of the hall, to be set as a microphone, and the linkage terminal 2C and the linkage terminal 2D to be set as a speaker. Furthermore, the linkage terminals 2E and 2F are instructed to be set as a speaker, and the linkage terminals 2G and 2H are instructed to be set as a microphone.

In the example, moreover, the lecturer 5 operates the central control device 1 to instruct the linkage terminal 2A to the linkage terminal 2D to be set as channel A, and the linkage terminal 2E to the linkage terminal 2H to be set as channel B. The control circuit 11 of the central control device 1 instructs the audio signal processing portion 12 to mix microphone beam signals supplied from the linkage terminals 2 for the respective channels, to produce collected audio signals and sound emission signals, and to output the sound emission signals of the respective channels to the linkage terminals 2 of the same channels.

In this case, audio signals (microphone beam signal) which are collected in the linkage terminal 2A and the linkage terminal 2B are input to the central control device 1, and subjected to mixing to be formed as a collected audio signal of channel A. In the linkage terminal 2A and the linkage terminal 2B, the peripheral region of the lecturer 5 is set as the sound collection range (directionality of sound collection). The collected audio signal contains a voice uttered by the lecturer 5.

The central control device 1 applies a process of adjusting the sound quality, such as equalizing to the collected audio signal of channel A, and outputs a resulting signal to the linkage terminal 2C and the linkage terminal 2D as a sound emission signal. In this case, the voice uttered by the lecturer 5 is loudly emitted from the middle of the hall to the front area.

Furthermore, audio signals (microphone beam signal) which are collected in the linkage terminal 2G and the linkage terminal 2H are input to the central control device 1, and subjected to mixing to be formed as a collected audio signal of channel B. In the linkage terminal 2G and the linkage terminal 2H, the peripheral region of the lecturer 9 is set as the sound collection range (directionality of sound collection). The collected audio signal contains a voice uttered by the lecturer 9.

The central control device 1 applies a process of adjusting the sound quality, such as equalizing to the collected audio signal of channel B, and outputs a resulting signal to the linkage terminal 2E and the linkage terminal 2F as a sound emission signal. In this case, the voice uttered by the lecturer 9 is loudly emitted from the middle of the hall to the rear area.

As described above, even in the case where different lectures are made in the same hall, the numbers and installation locations of speakers and microphones can be easily changed simply by operating the central control device 1, and the lectures can be easily set to be performed separately and concurrently.

Next, a measurement of the initial parameters of the adaptive howling canceller, and a reading operation during switching of the operation in the audio signal processing portion 12 will be described.

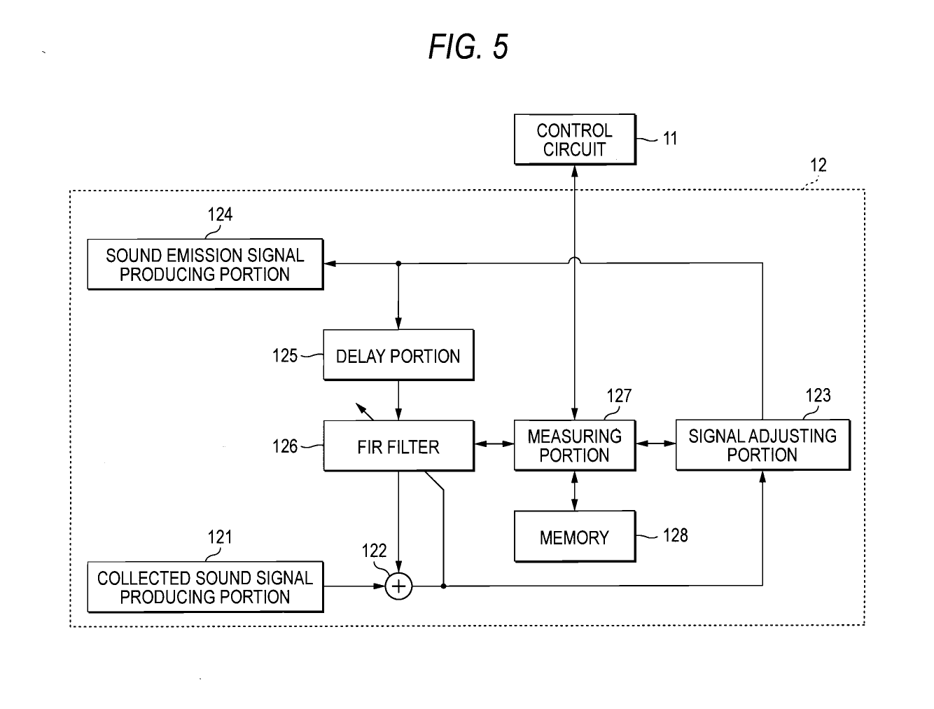

FIG. 5 is a functional block diagram of the audio signal processing portion 12. These functional portions may be realized by hardware, or by software (one or more CPUs or DSPs).

The audio signal processing portion 12 includes a collected audio signal producing portion 121, an adder 122, a signal adjusting portion 123, a sound emission signal producing portion 124, a delay portion 125, an FIR filter 126, and a measuring portion 127.

As described above, the collected audio signal producing portion 121 mixes microphone beam signals supplied from the linkage terminals 2 which function as a microphone, to produce a collected audio signal. The collected audio signal is subjected to a process in which pseudo echo sound is removed in the adder 122, and input to the signal adjusting portion 123.

The signal adjusting portion 123 applies a process of adjusting the sound quality, such as equalizing to the collected audio signal, and outputs a resulting signal to the sound emission signal producing portion 124 and the delay portion 125. When instructed to output a measurement signal (white noise or the like) by the measuring portion 127, moreover, the signal adjusting portion 123 outputs the measurement signal to the sound emission signal producing portion 124 and the delay portion 125. The sound emission signal producing portion 124 produces a sound emission signal from the collected audio signal which has undergone the sound quality adjustment (or the measurement signal), and outputs the sound emission signal to the linkage terminals 2 which function as a speaker.

The delay portion 125 provides the signal input from the signal adjusting portion 123 with a delay amount corresponding to the delay (the delay from the speaker to the microphone) of the acoustic feedback system, and outputs the delayed signal to the FIR filter 126.

In the FIR filter 126, filter coefficients which simulate the transfer function of the acoustic feedback system are set, and a pseudo echo sound signal is produced based on the delayed signal. The pseudo echo sound signal is output to the adder 122, and removed from the collected audio signal.

The collected audio signal (residual signal) from which the pseudo echo sound signal has been removed is input to the FIR filter 126 to be used in updating of the filter coefficients.

When the measurement of the acoustic feedback system is instructed by the lecturer or the like at, for example, the installation of the loudspeaker system, the measuring portion 127 instructs the control circuit 11 to cause a part of the linkage terminals 2 (for example, the linkage terminals 2A and 2B) to function as a microphone, and another part of the linkage terminals 2 (for example, the linkage terminals 2C to 2H) to function as a speaker. Furthermore, the measuring portion 127 sets the signal adjusting portion 123 so as to output the measurement signal, and reads the filter coefficients of the FIR filter 126. The measuring portion 127 stores the read filter coefficients in a built-in memory 128. After a certain time elapses from the instructions for outputting the measurement signal (after the adaptation of the FIR filter 126 proceeds), the measuring portion 127 reads out the filter coefficients, and stores the coefficients in the built-in memory 128.

The measuring portion 127 performs the measurement operation a plurality of times while changing the speaker/microphone operation pattern of the linkage terminals 2. The filter coefficients for respective patterns are correspondingly stored. Ideally, the filter coefficients are previously measured for all patterns. Alternatively, the measurement may be performed only for patterns which are designated by the lecturer or the like.

In the case where, during the actual use of the loudspeaker system (during a lecture), the lecturer or the like switches linkage terminals which are to function as a speaker or as a microphone, the measuring portion 127 receives information indicative of the speaker/microphone operation pattern from the control circuit 11, reads out the filter coefficients stored in the built-in memory, and sets the coefficients in the FIR filter 126.

In the loudspeaker system of the embodiment, as described above, the filter coefficients of the FIR filter in which the adaptation somewhat proceeds at the installation are previously measured, and read at the actual use, so that, even in the case where the acoustic feedback system is changed, the filter coefficients are immediately switched to those in which the adaptation proceeds, and the loudspeaker system does not become unstable.

In the above-described example, the configuration where the filter coefficients of the FIR filter are previously read and stored has been shown. Alternatively, also a configuration in which parameters for updating the filter coefficients, such as the step size are changed may be possible. In the case where, during the actual use of the loudspeaker system (during a lecture), the lecturer or the like switches linkage terminals which are to function as a speaker or as a microphone, namely, the measuring portion 127 sets the step size and the like of the FIR filter 126 so that updating becomes faster, and, after the adaptation proceeds to a certain degree, performs setting so that the step size and the like are returned to the original values. Also the setting which is performed so that, only when the acoustic feedback system is changed, updating of the filter coefficients becomes faster does not cause the loudspeaker system to become unstable.

Hereinafter, the functions and effects of the invention will be described.

According to the loudspeaker system of the invention, the central control device collectively controls the plurality of linkage terminals so that it is possible to easily change the functions of the linkage terminals between a speaker and a microphone, and hence the numbers and installation positions of speakers and microphones can be easily changed in accordance with the scale of the hall.

Moreover, it is possible to, through the central control device, designate which ones of the linkage terminals function as a microphone or as a speaker, and therefore the lecturer (or an assistant) can switch with one touch operation the locations of microphones and speakers in accordance with the situation during a lecture, such as a situation where the lecturer makes a lecture, that where a questioner puts a question, or that where the master of meeting gives an explanation. For example, the assistant is not required to go to the trouble of bringing a microphone to a questioner, it is possible to adequately response to the moving state of the person speaking, and the versatility and the convenience are very high.

The central control device incorporates an adaptive howling canceller (or an echo canceller), and, at the installation (in calibration), performs measurement on the acoustic feedback system with respect to a plurality of patterns related to functions and placements of a plurality of linkage terminals (various patterns of which ones of the linkage terminals function as a microphone or as a speaker). In accordance with measured acoustic feedback systems, initial parameters (filter coefficients and the like) are previously stored, and, when the pattern of speakers and microphone is switched during a lecture, the initial parameters are automatically read out. Therefore, the sound reinforcement state does not become unstable.

In the linkage terminals, the directionality is controlled by means of a speaker array and a microphone array. In the case where the linkage terminals are disposed in the vicinity of side wall faces of a room, for example, the direction of sound collection and that of the listener are perpendicular to each other because the listener is directed in the front direction. When the directionality of sound emission and that of sound collection are oriented toward the listener, the SN ratio can be ensured.

The central control device may be configured so that the collected audio signal is divided into a plurality of channels, and linkage terminals from which the output operation is to be performed are set. Even in the case where different lectures are made in the same hall, sound collection and sound emission are enabled to be performed for respective places, simply by operating the central control device, and the lectures can be easily set to be performed separately and concurrently.

Although the invention has been described in detail and with reference to the specific embodiment, it is obvious to those skilled in the art that various changes and modifications can be made without departing from the spirit and scope of the invention.

The application is based on Japanese Patent Application (No. 2009-002271) filed Jan. 8, 2009, and the subject matters of which are incorporated herein by reference.

### INDUSTRIAL APPLICABILITY

According to the invention, it is possible to provide a loudspeaker system which has a high degree of versatility, and which, even when the person speaking moves, can adequately response to the movement, and a sound emission and collection method which uses the loudspeaker system.

### DESCRIPTION OF REFERENCE SIGNS

1—central control device,
2A to 2H—linkage terminal

The status of the claims as presently amended is as follows:

1. A loudspeaker system comprising:
a central control device; and
a plurality of linkage terminals which are connected to the central control device,
wherein the central control device includes:
a control circuit which transmits a control command indicating whether each of the plurality of linkage terminals functions as a speaker or as a microphone; and
an audio signal processing portion which, when receiving an audio signal from a linkage terminal that functions as a microphone, applies audio signal processing to the audio signal, and which outputs the audio signal subjected to the audio signal processing to a linkage terminal that functions as a speaker; and
wherein each of the plurality of linkage terminals includes:
a sound collection portion which collects sound;
a sound emitting portion which emits sound; and
a terminal control circuit which, when receiving a control command for causing the linkage terminal to function as the microphone from the central control device, controls to output the sound that is collected by the sound collection portion to the audio signal processing portion of the central control device, and which, when receiving a control command for causing the linkage terminal to function as the speaker from the central control device, controls to emit sound from the sound emitting portion based on the audio signal that is input from the audio signal processing portion of the central control device.

2. The loudspeaker system according to claim 1, wherein the audio signal processing portion includes:
an adaptive pseudo echo sound removing unit which removes pseudo echo sound from the audio signal that is input from the linkage terminal; and
a storage portion configured to store a plurality of initial parameters of the adaptive pseudo echo sound removing unit; and
wherein the central control device further includes a measuring portion which performs measurement on an acoustic feedback system with respect to a plurality of patterns related to functions and placements of the plurality of linkage terminals, and which determines the plurality of initial parameters based on a result of the measurement.

3. The loudspeaker system according to claim 1, wherein the sound collection portion includes a microphone array having a plurality of microphones; and
wherein the sound emitting portion includes a speaker array having a plurality of speakers.

4. The loudspeaker system according to claim 1, wherein the control circuit of the central control device sets either of first and second channels to the plurality of linkage terminals; and
wherein the audio signal processing portion applies audio signal processing to an audio signal which is input from a linkage terminal that is set to the first channel, and that is caused to function as a microphone, outputs the audio signal that has undergone the audio signal processing, to a linkage terminal that is set to the first channel, and that is caused to function as a speaker, applies audio signal processing to an audio signal which is input from a linkage terminal that is set to the second channel, and that is caused to function as a microphone, and outputs the audio signal that has undergone the audio signal processing, to a linkage terminal that is set to the second channel, and that is caused to function as a speaker.

5. A sound emission and collection method for a loudspeaker system including a central control device and a plurality of linkage terminals which are connected to the central control device, the sound emission and collection method comprising:
transmitting a control command indicating whether each of the plurality of linkage terminals functions as a speaker or as a microphone, from the central control device;
outputting an audio signal which is collected by the linkage terminal to the central control device by a linkage terminal which receives a control command that causes the linkage terminal to function as the microphone;
when the central control device receives the audio signal from the linkage terminal which is caused to function as the microphone, applying audio signal processing to the audio signal, and outputting the audio signal subjected to the audio signal processing; and
emitting sound from a sound emitting portion based on the audio signal that is input from the central control device by a linkage terminal which receives a control command that causes the linkage terminal to function as the speaker.

6. The sound emission and collection method according to claim 5, further comprising:
performing measurement on an acoustic feedback system with respect to a plurality of patterns related to functions and placements of the plurality of linkage terminals;
determining a plurality of initial parameters based on a result of the measurement in the measurement step; and
removing pseudo echo sound from audio signals that are input from the plurality of linkage terminals, by using the plurality of initial parameters which are read out from a storage portion.

7. The sound emission and collection method according to claim 5, further comprising:
setting either of first and second channels to the plurality of linkage terminals;
applying audio signal processing to an audio signal which is input from a linkage terminal that is set to the first channel and that is caused to function as the microphone, and outputting the audio signal subjected to the audio signal processing to a linkage terminal that is set to the first channel and that is caused to function as the speaker; and
applying audio signal processing to an audio signal which is input from a linkage terminal that is set to the second channel and that is caused to function as the microphone, and outputting the audio signal subjected to the audio signal processing to a linkage terminal that is set to the second channel and that is caused to function as the speaker.
